(19) United States
(12) Patent Application Publication
(10) Pub. No.: US 2005/0202287 A1
(43) Pub. Date: Sep. 15, 2005

(54) Thermally isolated granular media for heat assisted magnetic recording

(75) Inventors: Bin Lu, Pittsburgh, PA (US); Dieter Weller, Gibsonia, PA (US); Ganping Ju, Wexford, PA (US)

Correspondence Address: Robert P. Lenart;Pietragallo, Bosick & Gordon, One Oxford Centre, 38th Floor, 301 Grant Street, Pittsburgh, PA, 15219, US

(73) Assignee: Seagate Technology LLC, Scotts Valley, CA (US)

(21) Appl. No.: 10/797,204

(22) Filed: Mar. 10, 2004

(51) Int. Cl. G11B 5/72; B05D 5/12

(52) U.S. Cl. 428/831.2; 427/128; 427/531

(57) ABSTRACT

A method of fabricating a magnetic storage medium comprises: forming an underlayer on a heat sink layer; co-sputtering a magnetic material and a thermally insulating nonmagnetic material to form a recording layer on the underlayer, wherein the recording layer includes grains of the magnetic material in a matrix of the thermally insulating nonmagnetic material; and heating the recording layer to align an easy axis of magnetization of the magnetic material in a direction perpendicular to the underlayer. A magnetic storage medium fabricated using the method is also provided.

### STATEMENT REGARDING FEDERALLY SPONSORED RESEARCH OR DEVELOPMENT

This invention was made with United States Government support under Agreement No. 70NANB1H3056 awarded by the National Institute of Standards and Technology (NIST). The United States Government has certain rights in the invention.

### FIELD OF THE INVENTION

This invention relates to the fabrication of thin films of magnetic material, and more particularly, to the fabrication of magnetic storage media with thin films having separated grains of magnetically hard material.

### BACKGROUND OF THE INVENTION

In thermally assisted optical/magnetic data storage, information bits are recorded on a layer of a storage medium at elevated temperatures. Heat assisted magnetic recording (HAMR) generally refers to the concept of locally heating a recording medium to reduce the coercivity of the recording medium so that an applied magnetic writing field can more easily direct the magnetization of the recording medium during the temporary magnetic softening of the recording medium caused by the heat source. For heat assisted magnetic recording a tightly confined, high power laser light spot can be used to preheat a portion of the recording medium to substantially reduce the coercivity of the heated portion. Then the heated portion is subjected to a magnetic field that sets the direction of magnetization of the heated portion. In this manner the coercivity of the medium at ambient temperature can be much higher than the coercivity during recording, thereby enabling stability of the recorded bits at much higher storage densities and with much smaller bit cells.

In HAMR, the size of the written bits is defined by either a magnetic field profile from the magnetic writer or the thermal profile from the heater. The sharpness of both magnetic and thermal profiles is important to achieve small bit size for high recording density.

Magnetic materials for HAMR media should have a very high magnetocrystalline anisotropy (Kᵤ). L1₀ phased materials, such as FePt and CoPt, are promising candidates. However, to make fully ordered L1₀ media, the thin films have to undergo a heat treatment at a high temperature (e.g. 600° C.). This thermal annealing process causes grain coarsening, which will ruin the media for high areal density recording.

Moreover, in order to keep a sharp thermal gradient in the media, the lateral heat transport needs to be reduced while a heat sink layer is needed to differentiate the thermal transporting perpendicularly and laterally. Hence, there is a need for a method of processing L1₀ HAMR media that provides thermally isolated grains of magnetic material in the recording layer.

### SUMMARY OF THE INVENTION

This invention provides a method of fabricating a magnetic storage medium comprising: forming an underlayer on a heat sink layer; co-sputtering a magnetic material and a thermally insulating nonmagnetic material to form a recording layer on the underlayer, wherein the recording layer includes grains of the magnetic material in a matrix of the thermally insulating nonmagnetic material; and heating the recording layer to align an easy axis of magnetization of the magnetic material in a direction perpendicular to the underlayer.

The thermally insulating nonmagnetic material can be an oxide. The magnetic material can be deposited as a chemically disordered phase with face centered cubic (fcc) structure that is transformed in the heating step into a chemically ordered L1₀ structure with face centered tetragonal (fct) structure. The heating step can be performed by heating the recording layer to between 600° C. and 700° C. for a period of 1 to 5 minutes. The heating step can be performed in a vacuum. The co-sputtering step can be performed in an argon gas containing oxygen.

In another aspect, the invention encompasses a magnetic storage media fabricated using the above method. The magnetic storage medium comprises an underlayer on a heat sink layer; a recording layer on the underlayer, the recording layer including a magnetic material and a thermally insulating nonmagnetic material, wherein the recording layer comprises grains of the magnetic material in a matrix of the thermally insulating nonmagnetic material; and wherein the grains of the magnetic material have an easy axis of magnetization in a direction perpendicular to the underlayer. The grains of the magnetic material have a face centered tetragonal structure.

### BRIEF DESCRIPTION OF THE DRAWINGS

FIG. 1 is a schematic representation of a heat assisted magnetic recording medium constructed in accordance with this invention.

FIG. 2 is a graph of the coercivity and squareness dependence on annealing temperature for CoPt and SiO₂ media.

FIG. 3. is a graph of the coercivity and squareness dependence on annealing temperature for CoPt—O media.

FIG. 4. is a graph of the coercivity and squareness dependence on annealing temperature for CoPt—O and Al₂O₃ media.

FIG. 5 is a graph of the thermal conductivity of ZrO₂ thin film vs. grain size.

### DETAILED DESCRIPTION OF THE INVENTION

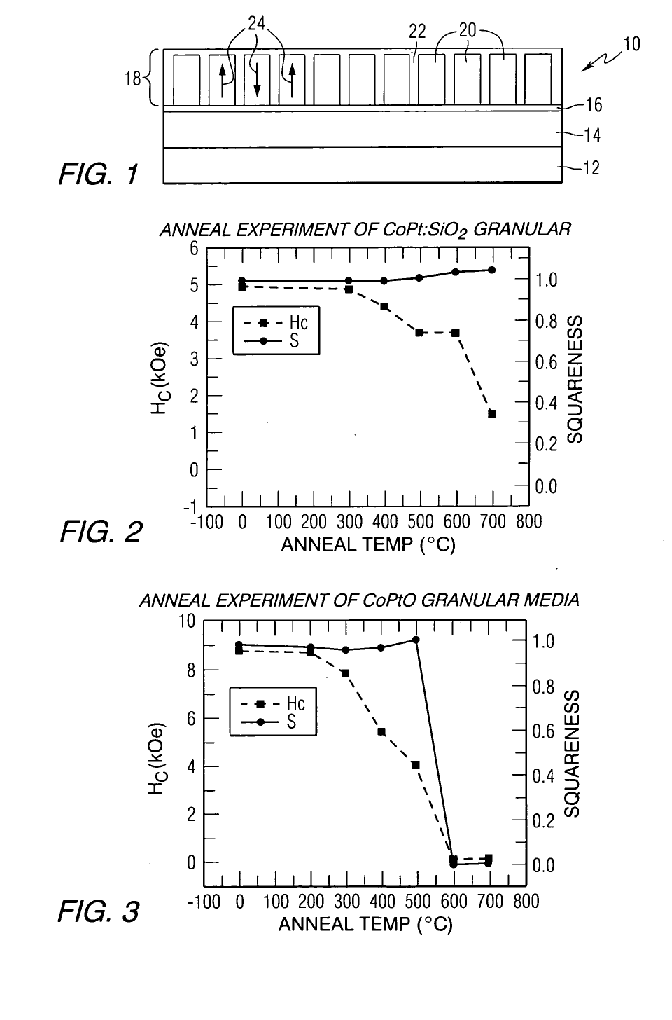

FIG. 1 is a schematic representation of a HAMR medium 10 constructed in accordance with this invention. The medium includes a substrate 12, a thermally conducting heat sink layer 14, an underlayer 16, and a recording layer 18. The underlayer can be a multilayer structure, and a seed layer can be positioned between the underlayer and the substrate. The recording layer includes a plurality of grains 20 of magnetically hard material embedded in a thermally insulating, nonmagnetic matrix material 22. The grains have magnetic easy axes in directions perpendicular to the plane of the recording layer as illustrated by arrows 24. With this design, heat can transfer more easily in a direction perpendicular to the medium while lateral heat transfer is very small. This limits the size of the portion of the media which is heated during the recording process. Therefore the thermal profile on such a medium is extremely sharp. The substrate can be for example, a glass material. Additional layers, such as a lubricant layer, can also be included.

The media of FIG. 1 includes an insulating matrix material in combination with a magnetically hard material to achieve desirable microstructures and magnetic properties of the media.

The magnetic material should have hard intrinsic magnetic properties and a microstructure that provides a perpendicular orientation of the magnetic easy axes, a narrow dispersion of the easy axis orientation, a fine grain size, and decoupling between the magnetic grains.

A heat sink layer is provided for supporting the magnetic recording layer. The heat sink layer can be a thick (for example, greater than 100 nm) metal layer of very high thermal conductivity, for example, Cu, Au, Ag, Al, etc. The heat sink layer can be supported by a substrate.

The grains of magnetically hard material can comprise, L1₀ phase hard magnetic materials, for example, CoPt or FePt. One or more thin underlayers are deposited on the heat sink material to control orientation and microstructure of the grains of magnetic material in the recording layer. For L1₀ structured materials the candidate materials for underlayers are Ta\MgO\Ag, Ta\MgO\Ag\MgO, etc. Since the surface of an MgO (100) layer has the lowest surface energy, when MgO is deposited onto an amorphous surface it will grow in a (100) crystallographic texture. A subsequent layer, for example Ag deposited on the MgO layer, will inherit the orientation in (100) texture. Then the chemically disordered face centered cubic (fcc) magnetic material will also take the (100) texture. When the fcc magnetic material is annealed, an fcc to face centered tetragonal (fct) phase transformation occurs. The stress at the Ag-magnetic material or MgO-magnetic material interface causes the chemically ordered magnetic material to grow with its (001) plane parallel to the surface. Consequently, the fct magnetic material will have its [001] direction (which is the magnetic easy axis) perpendicular to the film plane. In one example, the material used for the underlayer has a natural texture orientation of (100) and its (100) lattice plane matches with the FePt (001) lattice plane. Materials with MgO type structure have such unique ability. When such a material deposited onto an amorphous substrate it develops a (100) orientation naturally. Moreover, the (100) plane matches with FePt (001) plane nicely. A MgO\Ag\MgO multilayer usually has a better (100) orientation than a single MgO layer.

To construct the recording layer, the magnetically hard material, such as, CoPt or FePt can be co-sputtered with an oxide material or other thermally and magnetically insulating materials in order to form a granular magnetic material film imbedded in a thermally and magnetically insulating matrix. If an oxide is used, the oxide material should have low thermal conductivity and a similar thermal expansion coefficient with the magnetically hard material. Optionally, oxygen can be added to the sputtering system to maintain the oxide's stoichiometry as well as to better physically separate the grains of magnetic material. After the initial deposition of the recording layer, which comprises chemically disordered magnetic alloy grains embedded in an oxide matrix, the structure can be vacuum or rapidly thermal annealed. Actual annealing temperature and time varies with different film compositions, the amount of oxide, the method of annealing, etc. Annealing time can be adjusted according to the magnetic hardness, and the relative intensity of the ordering peak in an x-ray diffraction scan. Annealing temperature and time is limited by the grain growth, which is detrimental to the magnetic properties of the media. The annealing converts the magnetically hard material to an L1₀ structure. In one example, the annealing can take place at a temperature between 600° C. or 700° C. for a time period of one to five minutes. The oxide can include SiO₂, ZrO₂, TiO₂, MgO, or MgO/SiO₂. In particular, MgO provides a good lattice match. Other thermally insulating nonmagnetic materials that can be used for the matrix include: carbon, boron, a carbide, and a nitride.

Sputter overcoat materials can be applied after the thin films have cooled down. Post sputter processing such as lubing, buff/wiping and burnishing, etc. can then be performed.

The matrix material prevents the magnetic grains from touching each other. With this configuration, the magnetic grains will not diffuse into each other in the high temperature annealing process. The annealing orders the magnetic alloy grains into L1o structures with high magnetocrystalline anisotropy.

In an example wherein the magnetic material is FePt, the chemically disordered phase of the structure of the FePt is fcc. Therefore c=a, i.e. c/a=1. In the chemically ordered phase the structure of the FePt is fct. In this case, c<a, and c/a˜0.98. The as-deposited magnetic grains are oriented in the <100> direction on MgO (100). If there is an in-plane tensile stress due to interfacial lattice mismatch, the grains that align in the [001] direction are preferred due to their low interfacial energy. The resulting FePt film will consequently have a magnetic easy axis perpendicular to the film. SiO₂ has been used as the thermally insulating material. The thermal conductivity of SiO₂ is 1.6 W/mK at 373° K, and 1.8 W/mK at 673° K. This value is one of the lowest among all of the oxides.

FIG. 2 shows magnetic results of an annealing experiment, which was designed to test the robustness of the oxide matrix as a diffusion barrier. In the example illustrated in FIG. 2, the as-deposited media included perpendicularly oriented hexagonal close packed (hcp) CoPt grains in a SiO₂ matrix (total 9 nm) on top of a Ru underlayer (18 nm) on a Pt seedlayer (3 nm) on a ceramic glass substrate. During the co-deposition of CoPt and SiO₂, oxygen (0.6% in total O₂ plus argon flow) was present in the deposition chamber. The as-deposited disc was cut into several pieces and annealed in a rapid thermal annealing system at temperatures from 300° C. to 700° C.

Even though the medium did not contain a L1₀-phased material, the experimental results show that SiO₂ barrier can hold the magnetic hardness up to ˜600° C. The loop squareness of the film remains at unity up to 700° C.

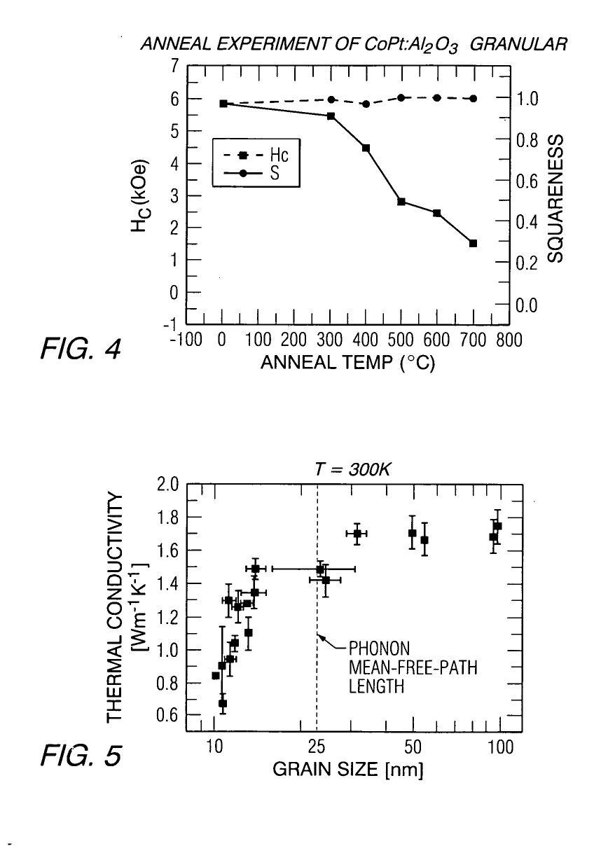

The results for the SiO₂ thermal barrier have been compared to CoPt—O granular media with CoPt reactively sputtered with O₂ (0.8% flow) and a media with an Al₂O₃ matrix. FIGS. 3 and 4 show the results of an annealing experiment for the two types of media with the same underlayer, seed layer and substrate. It can be seen that the oxide shell in the CoPt—O media is not robust enough to prevent inter-grain diffusion. As a result, the hard magnetic properties vanish above 500° C., which is too low a temperature to introduce L1₀ ordering. The Al₂O₃ matrix is better than the oxide shell but worse than SiO₂ matrix.

Another example of the invention uses ZrO₂ as the thermal barrier. Bulk ZrO₂ has thermal conductivity of 2 W/mK at 373° K, 2 W/mK at 673° K. It is also one of the oxides that has the lowest thermal conductivity. Other oxides, such as TiO₂ (6.5 W/mK at 373° K, 3.8 W/mK at 673° K), or a mixture of the oxides, such as MgO+SiO₂ (5.3 W/mK at 373° K, 3.5 W/mK at 673° K), etc. are also good candidates for the matrix material.

It is important to note that the values set forth above were determined for bulk materials. For nanocrystalline or amorphous thin films, the value will be lower (better) due to more grain boundaries and surfaces causing perturbation to the heat transfer. FIG. 5 shows thermal conductivity of yttrium-stabilized ZrO₂ thin films against grain size of ZrO₂ as published by J. A. Eastman at Argonne National Laboratory. Since ZrO₂ has a coefficient of heat expansion that is similar to metals, ZrO₂ can easily be combined with a FePt alloy.

The oxide is selected to have an atomic diffusion barrier and low thermal conductivity. The FePt grains tend to grow larger at high annealing temperatures. Therefore the oxides at the grain boundaries need to form an atomic diffusion barrier constraining the growth of the FePt grains. The lateral thermal conductivity should be as low as possible in order to achieve sharp lateral thermal profiles.

The low thermal conductivity of the matrix material prevents lateral thermal diffusion in the surface of magnetic layer. Therefore during HAMR recording the temperature profile generated by the laser on the surface of the magnetic storage medium has sharp edges.

While the invention has been described in terms of several examples, it should be understood that various changes can be made to the disclosed examples without departing from the scope of the invention as set forth in the following claims.

1. A method of fabricating a magnetic storage medium comprising:
forming an underlayer on a heat sink material;
co-sputtering a magnetic material and a thermally insulating nonmagnetic material to form a recording layer on the underlayer, wherein the recording layer includes grains of the magnetic material in a matrix of the thermally insulating nonmagnetic material; and
heating the recording layer to align an easy axis of magnetization of the magnetic material in a direction perpendicular to the underlayer.

2. The method of claim 1, wherein the underlayer has a (100) crystallographic texture orientation.

3. The method of claim 1, wherein the underlayer comprises a material selected from the group of: MgO, Ag, Ta, and Ru.

4. The method of claim 1, wherein the insulating material is selected from the group of: an oxide, carbon, boron, a carbide, and a nitride.

5. The method of claim 1, wherein the insulating material is selected from the group of: SiO₂, ZrO₂, TiO₂, MgO, and MgO/SiO₂.

6. The method of claim 1, wherein the heating step heats the recording layer to between 600° C. and 700° C. for a period of 1 to 5 minutes.

7. The method of claim 6, wherein the heating step transforms the magnetic material from a face centered cubic structure into a face centered tetragonal structure.

8. The method of claim 1, wherein the heating step is performed in a vacuum.

9. The method of claim 1, wherein the co-sputtering step is performed in a gas containing oxygen.

10. The method of claim 1, wherein the magnetically hard material comprises an L1₀ alloy including Pt and one of Fe and Co.

11. The method of claim 1, wherein the underlayer comprises a multilayer structure of: MgO\Ag, MgO\Ag\MgO, Ta\MgO\Ag, or Ta\MgO\Ag\MgO.

12. The method of claim 1, wherein the heat sink comprises a material selected from the group of: Cu, Au, Ag, and Al.

13. A magnetic storage medium fabricated according to the method of claim 1.

14. A magnetic storage medium comprising:
an underlayer on a heat sink layer;
a recording layer on the underlayer, the recording layer including a magnetic material and a thermally insulating nonmagnetic material, wherein the recording layer includes grains of the magnetic material in a matrix of the thermally insulating nonmagnetic material; and
wherein the grains of the magnetic material have an easy axis of magnetization in a direction perpendicular to the underlayer.

15. The magnetic storage medium of claim 14, wherein the underlayer has a (100) crystallographic texture orientation.

16. The magnetic storage medium of claim 14, wherein the underlayer comprises a material selected from the group of: MgO, Ag, Ta, and Ru.

17. The magnetic storage medium of claim 14, wherein the insulating material is selected from the group of: an oxide, carbon, boron, a carbide, and a nitride.

18. The magnetic storage medium of claim 14, wherein the insulating material is selected from the group of: SiO₂, ZrO₂, TiO₂, MgO, and MgO/SiO₂.

19. The magnetic storage medium of claim 14, wherein the magnetically hard material comprises an L1₀ alloy including Pt and one of Fe and Co.

20. The magnetic storage medium of claim 14, wherein the underlayer comprises a multilayer structure of: MgO\Ag, MgO\Ag\MgO, Ta\MgO\Ag, or Ta\MgO\Ag\MgO.

21. The magnetic storage medium of claim 14, wherein the heat sink comprises a material selected from the group of: Cu, Au, Ag, and Al.
